(19) United States
(12) Patent Application Publication
(10) Pub. No.: US 2004/0148502 A1
(43) Pub. Date: Jul. 29, 2004

(54) Method and system for the distributed creation of a program for a programmable portable data carrier

(76) Inventors: Michael Gollner, Munchen (DE); Daniel Ciesinger, Munchen (DE)

Correspondence Address: BACON & THOMAS, PLLC, 625 SLATERS LANE, FOURTH FLOOR, ALEXANDRIA, VA, 22314

(21) Appl. No.: 10/467,334

(22) PCT Filed: Feb. 15, 2002
(86) PCT No.: PCT/EP02/01655

(30) Foreign Application Priority Data
Feb. 22, 2001 (DE) 101 08 487.0

(51) Int. Cl. H04L 9/00

(52) U.S. Cl. 713/167

(57) ABSTRACT

A method is proposed for distributed creation of a program for a programmable portable data carrier (10) e.g. a smart card. Program source text (Q) is created on a user computer (20), compiled and linked into executable program code (C) on a spatially separate compiler server (30), and the executable program code (C) loaded into data carrier (10) again via the user computer (20). A secure end-to-end link is set up for the data exchange between data carrier (10) and compiler server (30). For this purpose, the data carrier (10) is provided, in a precompletion step, with software tools for final processing that permit a transport code (U, C_{SSL}, UC_{SM}) provided in a transient format to be converted into executable program code (C). the transport code (U, C_{SSL}, UC_{SM}) is secured by encryption mechanisms. The transfer of the executable program code (C) generated by the compiler server (30) to the data carrier (10) is effected in the transient format (U, C_{SSL}, UC_{SM}).

This invention relates to the tamperproof creation of executable program code for programmable portable data carriers, preferably in the form of smart cards.

U.S. Pat. No. 6,023,565 discloses a method for distributed creation of a program for a programmable logic circuit. A user wishing to create a program for such a circuit by means of a computer located with him is provided here by the manufacturer of the circuits with an easily operated user interface. The user use computer the functionality desired for the logic circuit. Description is done in menu-driven fashion via input masks by means of which prepared parameters are defined. The resulting parameter record describing the desired circuit functionality is sent over a data network to a computer belonging to the circuit manufacturer. The latter compiles the parameter record and generates an executable program with the functionality desired by the user. The manufacturer sends the executable program back to the user's computer, which converts it into a programming instruction sequence that it transfers to the logic circuit. Since the program creation is reduced to the dialog-driven entry of parameters, the concept also permits users without any profound programming knowledge to create programs for logic circuits. Program creation is possible here without the user having any compiler software. The concept focuses on improving the user-friendliness of a technical system that is difficult to handle for structural reasons. No precautions are taken for protecting the data exchanged between the involved computers from manipulation. The concept is therefore not suitable for applications in which it is especially important to protect the generated program data from interception and manipulation. In particular, it is not suitable in the described form for creating programs for smart cards that are intended for performing security-relevant transactions, such as banking transactions.

U.S. Pat. No. 6,005,942 discloses a method for securely loading an executable application onto a smart card already in the field. The method makes it possible for application providers to add further applications to a card through the intermediary of the card issuer at any times during the life cycle of a smart card. Subsequent loading of an executable application is made possible by a special card domain routine that is associated with the issuer of the card and manages the keys and cryptographic mechanisms. The card domain routine is supported by security routines that likewise manage keys and cryptographic mechanisms but that are associated with the application provider and that secure applications to be downloaded vis-a-vis the card issuer. Applications to be downloaded are encrypted, being decrypted by the card domain routine with the support of the security routines and loaded into the card. Upon loading, a cryptographic signature is checked. This print does not deal with the creation of the applications to be downloaded starting out from an application program source text.

WO 99/12307 discloses a method for distributing commercial software starting out from a software manufacturer through intermediate dealers to ultimate buyers. The described method allows intermediate dealers to add additional information to software to be distributed without impairing the security of the executable core code of the software to be distributed. This is obtained by a special sending routine that encrypts software to be distributed and provides it with a special distribution information table. Intermediate dealers can only make changes or additions in the latter table.

Smart cards that allow downloading of executable program code and the incorporation of program codes to be downloaded into smart cards are described e.g. in “Handbuch der Chipkarten” by W. Rankl, W. Effing, Hansa Verlag Müunchen, 3^{rd} ed. Program creation is effected here completely on a background system. The created executable program code is transferred to the smart card via an interface, e.g. secured by mutual authentication. For security reasons the incorporation of the executable program code into the smart card is preferably effected online, after unique identification and association of background system, interfaces, card operating system and card microprocessor have been effected. To guarantee the manageability of the background system data bases containing the identification information while maintaining maximum security, the authorizations to create executable program code on background systems are only granted by the card issuers with conditions imposed and the granted and the granted authorizations are listed. This limits the fundamentally provided possibility of creating executable program code for smart cards oneself.

To secure data exchange between two computers conducted over an open data network, a number of methods based on different encryption techniques are known, including the SSL (Secure Socket Layer) protocol, PGP (Pretty Good Privacy), Secure Messaging and the SMIME protocol. Methods of this kind are also used in the inventive methods described below, but are not per se the subject matter of the invention. For details of execution including cryptological realization, reference is therefore made in general to the many different available descriptions of the particular methods in the pertinent literature and on the Internet. The same applies to the customary means used in connection with data protection methods such as encryption by the 3DES method or formation of Message Authentication Codes (MACs).

The invention is based on the problem of stating a method that makes it possible to allow a very large group of users to create executable programs for programmable portable data carriers while maintaining maximum security against data manipulation. It is also the problem of the invention to state the system components required for carrying out the method.

The problem is solved by a method having the features of the main claim. According to the invention, a. user is provided with a program editor for creating program source texts and a precompleted portable data carrier having software tools for final processing that allow transport code present in a transient format to be converted into executable program code. Creation of an executable program for the data carrier is done in distributed fashion. The user uses the program editor to create a program source text, which is subsequently transferred to a computer located with the issuer of the data carrier over a secure connection. The secure connection can be established by a program source text being encrypted into a transport code by the precompleted data carrier itself, and protected from change such that only a certain recipient addressed by a computer located with an issuer of the data carrier can decrypt the transport code and check its integrity.

From the received program source text, the computer located with the issuer of the data carrier generates an executable program code by compiling and linking. Part of the compiling and linking process is a formal verification of the generated program codes, by which in particular aggressive code is determined. The computer located with the issuer of the data carrier converts the verified executable program code into a transient format and transfers it via the user's computer to the precompleted portable data carrier. The latter converts it back to executable program code with the aid of the final processing software tools and accepts it in its memory.

Preferably, the security-relevant parts of the final processing software are contained in the precompleted data carrier. Thus, in particular the decryption and/or the ascertainment of the authenticity and/or integrity of a transport code containing a program code are expediently performed in the precompleted data carrier itself, before the resulting executable program code is stored in the memory of the data carrier if there are no errors.

The inventive method provides a secure end-to-end link between a computer located with an issuer and a data carrier via a computer located with a user. The design of the precompletion and the choice of software tools make it easy to adapt to the type and technical possibilities of the particular data carriers given. If the data carriers are only set up for executing symmetric encryption methods, a secure end-to-end link is expediently established by using a symmetric card-unique key, on the one hand, and a superimposed, simplified asymmetric encryption on the data link between the user's computer and the computer located with the issuer of the data carrier, on the other hand. In an alternative embodiment, data transfer between the user's computer and the computer located with the issuer of the data carrier is secured by effecting asymmetric encryption with reciprocal authentication and setting up the secure end-to-end link between the computer located with the issuer and the data carrier with the mechanisms of Secure Messaging.

If the data carriers are set up for performing asymmetric encryption methods, an end-to-end link secured by asymmetric encryption is expediently formed directly between the computer located with the issuer of the data carrier and the data carrier. The user's computer acts only as an intermediary here.

The inventive method has the advantage that the creation of executable programs for a data carrier can be left fundamentally to any users without the user's identity having to be ascertained and managed. Since the issuer of the data carriers is included in every program creation, the security of the generated programs and thus the total system is always guaranteed. Because in particular the compiler functionality remains with the issuer of the data carriers, no important and security-relevant know-how need be given to the users.

By designing the compiler functionality so as to block direct, unencrypted access to program source texts coming from users or executable program codes generated by users, it can be ensured vice-versa that the users' application-specific know-how is protected from the issuer. For this purpose, the computer located with the issuer expediently uses a hardware security module in which compiler functionality, encryption/ decryption of programs, check/creation of signatures and authentication are performed. Outside the hardware security module, program source texts or executable program codes appear only in encrypted form.

The formal verification of newly created programs by the issuer, i.e. in a secure environment, further prevents very reliably the incorporation of aggressive program codes into systems usable by means of a data carrier. It moreover results in the advantage that all created executable programs are compiled with the most current compiler. The inventive method can be performed online or offline. For the issuers of data carriers, the inventive method even opens up the possibility of leaving the creation of the particular desired executable application programs wholly to the users and delivering the data carriers only in precompleted form. The involvement of the issuer in a program creation as always required by the distributed program creation additionally permits the introduction of utilization methods that employ charging models based e.g. on the number or type of executable programs added to a data carrier.

An example of the invention will be explained in more detail in the following with reference to the drawing, in which:

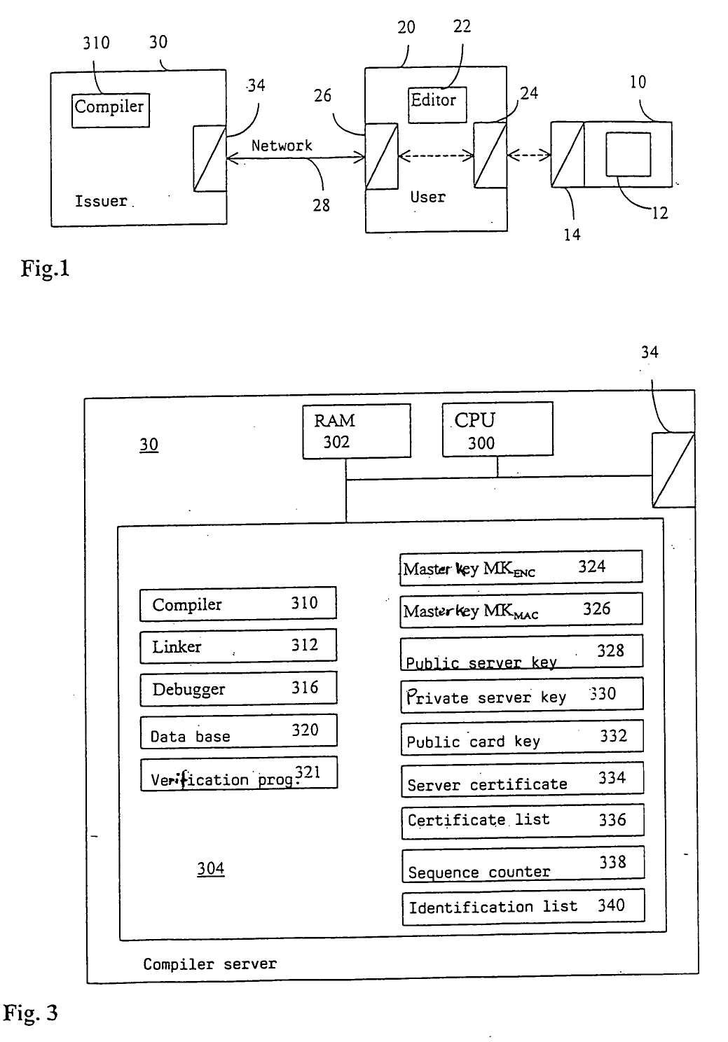

FIG. 1 shows a system for executing a program creation,

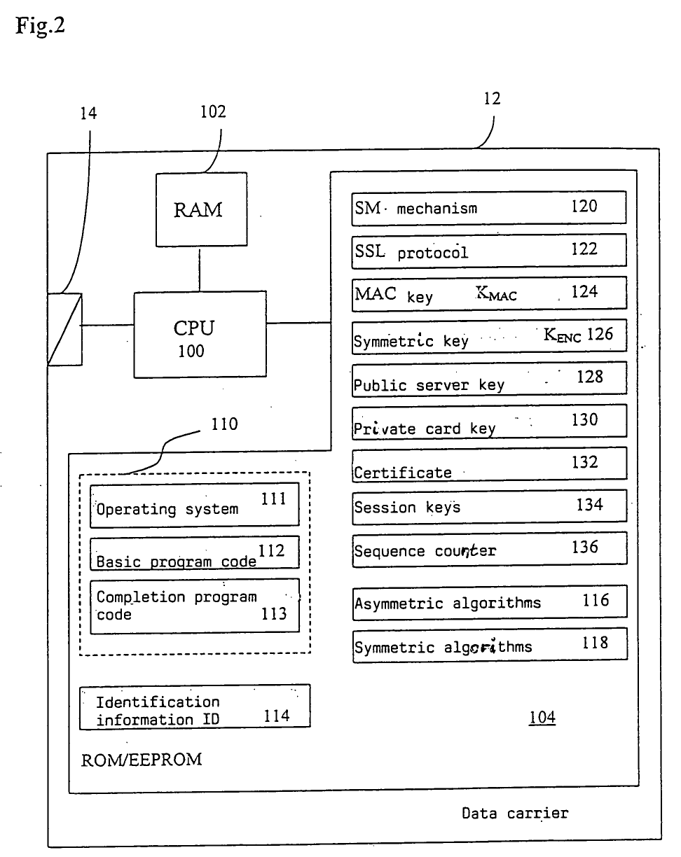

FIG. 2 shows the structure of the integrated circuit of a programmable portable data carrier,

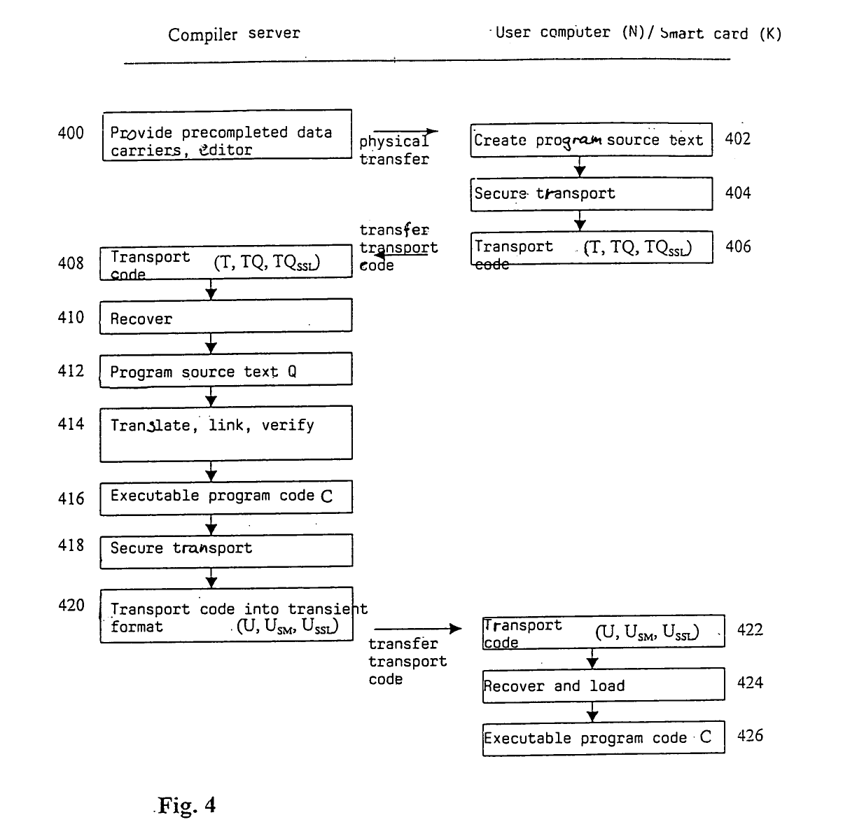

FIG. 3 shows the structure of a second computer,

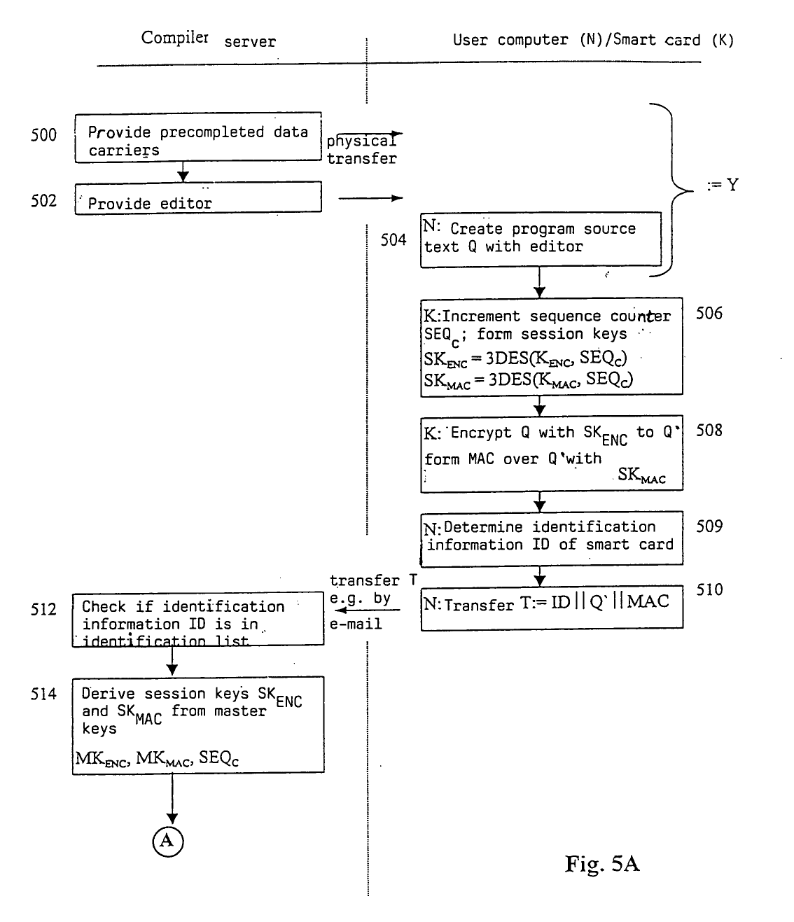

FIG. 4 shows the basic sequence of a distributed program creation,

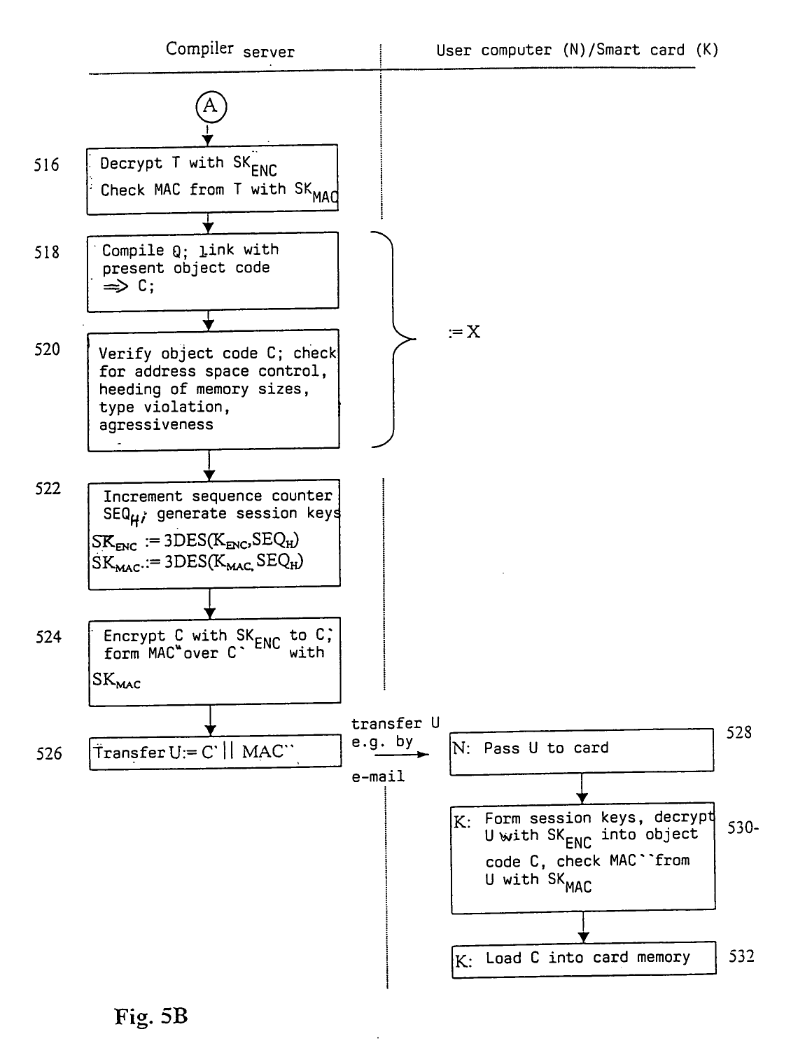

FIGS. 5 to 7 show flowcharts to illustrate the sequence of a program creation,

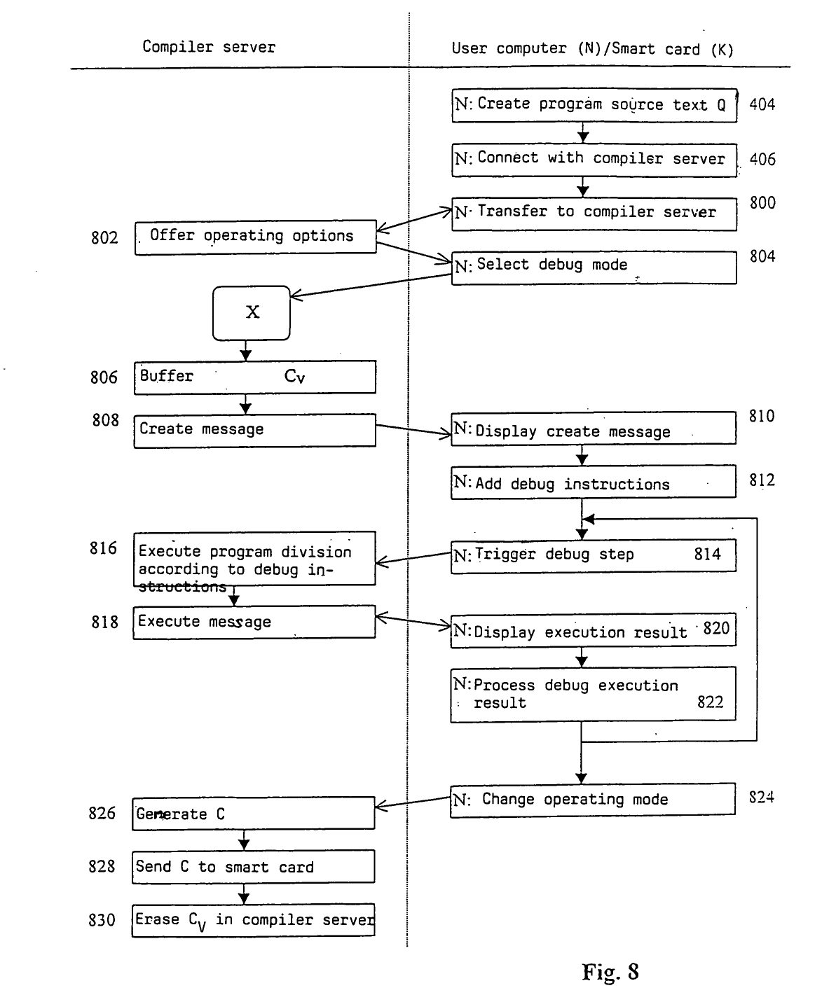

FIG. 8 shows the principle of an online check of a created program for executability.

FIG. 1 illustrates the basic structure of a system for distributed creation of a program for a programmable portable data carrier. First computer 20 designed for data exchange with portable data carrier 10 is connected via data link 28 with second computer 30.

First computer 20 is located with a user, e.g. at a bank, insurance company, retailer, medical facility or the like, or with a service provider that creates programs on behalf of the aforementioned facilities. It has first, contact-type or contactless-type interface 24, which can be realized e.g. as a contact bank, in the form of a coil or as an optical signal generator and which permits data exchange with portable data carrier 10. Via further interface 26 it is connected to data link 28. Via the two interfaces 24, 26 user computer 20 connects data carrier 10 with data link 28. User computer 20 thereby provides additional functions for data carrier 10. In particular, it permits the operation of editing program 22, referred to hereinafter as the editor for short, which allows the creation of source texts of programs for data carrier 10.

For programmable portable data carrier 10, the form of a smart card will subsequently be taken as a basis. However, it is by no means limited to this form of appearance. Adapted to the particular use, data carrier 10 may instead be formed differently, differently, e.g. as a watch, writing utensil, etc. Independently of its specific form of appearance, portable data carrier 10 has interface 14 corresponding to interface 24 of user computer 20 to permit data exchange with user computer 20. In addition, portable data carrier 10 has integrated circuit 12 having a central processor unit and a memory for receiving the program code of at least one application program executable by the central processor unit.

Second computer 30 is typically located with an issuer of portable data carriers 10 or with an authorized operator of the method described here. Normally, it has much greater computing power in comparison with that of user computer 20 or portable data carrier 10. Second computer 30 need not be realized as a structural unit. It may rather be executed as a system with distributed components that are connected over a special data network. Hardware security modules can be used for storing or executing security-critical functions. Second computer 30 is connected to data link 28 via interface 34. Second computer 30 is designed in particular for executing compilation program 310 for converting a source text program present in a high-level programming language into machine language; it will therefore be referred to hereinafter as the compiler server.

Data link 28 usually has the form of a data network and can be realized in particular by the Internet. Although FIG. 1 only shows a connection between two components 20, 30, a plurality of user computers 20 can also be connected with one or with a plurality of compiler servers 30 over data link 28 referred to hereinafter as the data network.

FIG. 2 shows the structure of integrated circuit 12 of smart card 10 with software tools applied as precompletion. Integrated circuit 12 has an architecture typical of smart card processors, having central processor unit 100, volatile working memory 102 and nonvolatile memory array 104, the latter comprising a nonvolatile read-only memory and a nonvolatile rewritable memory. Usually, volatile working memory 102 is a RAM, the nonvolatile read-only memory a ROM, and the nonvolatile rewritable memory an EEPROM. Besides the stated types of memory, any others having the same functionality can be used. Central processor unit 100 is further connected with interface 14.

Nonvolatile memory array 104 contains a number of software tools required for use of data carrier 10 that are created in a precompletion phase before data carrier 10 is given to a user. Software tools refer here to all programs, routines or records that can not be changed by a user and are employable in case of need for executing certain data processing tasks. During precompletion, basic card configuration 110 is firstly created that is independent of execution and always the same. It comprises at least operating system 111, basic program code 112 for realizing applications already located on smart card 10 when given to the user, and memory area 113 for later receiving down loaded executable program code.

Secondly, a selection of the following software tools coordinated with the particular embodiment chosen is created: individual identification information 114 unique to integrated circuit 12 and thus to smart card 10, e.g. a serial number, program 116 for performing asymmetric cryptographic algorithms, program 118 for carrying out symmetric cryptographic algorithms, program 120 for conducting data exchange according to the principle of Secure Messaging, program 122 for carrying out data exchange over data network 28 according to the SSL protocol, smart card-unique signature key 124, smart card-unique symmetric key 126, public key 128 of compiler server 30 associated with smart card 10, private card key 130 for use in an asymmetric encryption method, certificate 132 for confirming the concurrence between public card keys and identification information with a signature of an issuer, memory space for receiving session key 134—this being newly generated at each commencement of data exchange with compiler server 30 unlike the aforementioned keys—and sequence counter 136. Each stated software tool can also be present several times. This applies particularly to the stated keys, certificates and sequence counter.

FIG. 3 illustrates the structure of compiler server 30 with the programs and software tools used during program creation. The core of compiler server 30 is central processor unit 300 which is connected via interface 34 with data network 28 to conduct thereover a data exchange with user computer 20 and thus with smart card 10. Central processor unit 300 further has associated therewith volatile working memory 302, normally in the form of a RAM, and nonvolatile memory array 304, which usually comprises a read-only memory (ROM) and a bulk memory, e.g. a hard disk.

Memory array 304 stores the software tools required for carrying out the proposed method. FIG. 3 shows for simplicity's sake an overview of all software tools that can be used in connection with this description. The selection of actually required software tools depends, as with smart card 10, on the embodiment specifically chosen for realizing the method. In general, memory array 304 can contain the software tools: compilation program 310, referred to as compiler in FIG. 3, for converting program source text into a program code, linking program 312, referred to as linker in FIG. 3, for linking already created program codes into the context of a newly created program, code library 318 with the program code of programs and program parts already present, data base 320 for storing program codes associated with certain users, debug program 316 for testing a created program for executability, program 321 for formal verification of generated programs and/or source texts, one or more major keys 324 corresponding to smart card-unique, symmetric key or keys 126, one or more major keys 326 corresponding to smart card-unique keys 124 for forming data protection codes, in particular MACs, one or more public server keys 328 for carrying out asymmetric cryptographic algorithms, one or more corresponding private server keys 330, one or more public card keys 332 for carrying out asymmetric algorithms, one or more server certificates 334, one or more sequence counters 338, and a list of certificates formed during production of precompleted smart card 10 and stored in smart card 10 in area 132. Memory array 304 in addition comprises user list 340 with identification information that permits unique identification of a smart card; identification information for identifying smart cards 10 can be their serial numbers, for example.

Expediently, only the actually required software tools among the aforementioned are set up in compiler server 30 in the practical realization of the method; those not required are left out.

The importance and use of the software tools present in precompleted smart card 10 or compiler server 30 will be explained in the following with reference to FIG. 4, which shows the basic sequence of a distributed program creation, and FIGS. 5 to 7, which illustrate three embodiments of a distributed program creation.

FIG. 4 first shows the basic sequence of a distributed program creation. In a preparation phase, a user is provided with smart card 10 precompleted by application of software tools as well as editor 22, step 400. With editor 22 he creates program source text Q on user computer 20, step 402. Application of a suitable encryption technology provides said text with a transport security mechanism, step 404, and converts it into transport code T, TQ, TQ_{SSL}, step 406. Transport code T, TQ, TQ_{SSL} is transferred to compiler server 30, step 408.

Compiler server 30 eliminates the transport security mechanism by decryption, step 410, and recovers program source text Q contained in transport code T, TQ, TQ_{SSL}, step 412. It then compiles, links and verifies program source text Q, step 414. The result is executable program code C, step 416, which is subsequently transport secured again, step 418. For this purpose it is converted into transient format U, U_{SM}, U_{SSL} by application of suitable encryption mechanisms, which need not match those previously applied by user computer 20, step 420. In said transient format it is transferred via user computer 20 to smart card 10, step 422.

Said card determines executable program code C from transport code U, U_{SM}, USSL received in user computer 20 by decryption again using the software tools created during precompletion, and finally loads it into its memory.

FIG. 5 shows a distributed program creation in which data security is obtained by using means prepared on smart card 10 in interaction with compiler server 30. The embodiment shown in FIG. 5 is suitable particularly for systems in which smart cards 10 used are only capable of symmetric encryption techniques.

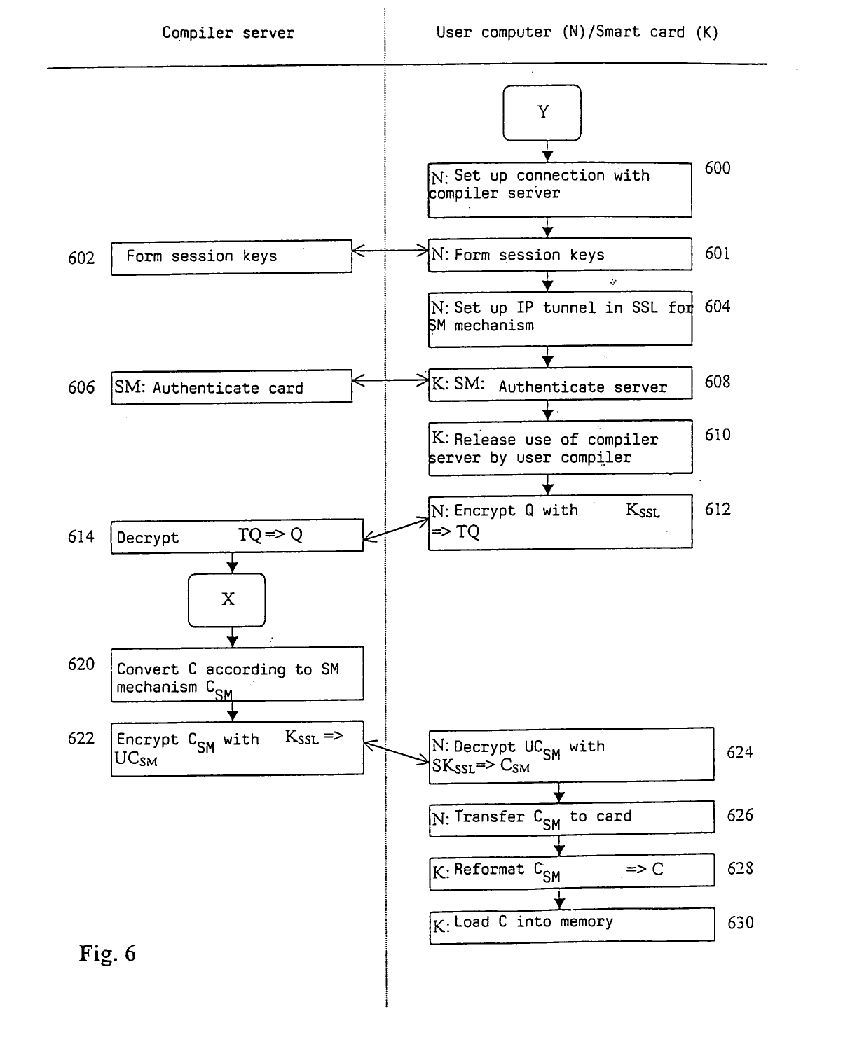

FIG. 6 shows an embodiment in which the data transfer effected between user computer 20 and compiler server 30 over data network 28 is protected by means of an SSL protocol, while the data transport effected directly between smart card 10 and compiler compiler server 30 is executed according to the Secure Messaging mechanism. This embodiment is likewise suitable for systems in which smart cards 10 used allow only symmetric encryption techniques.

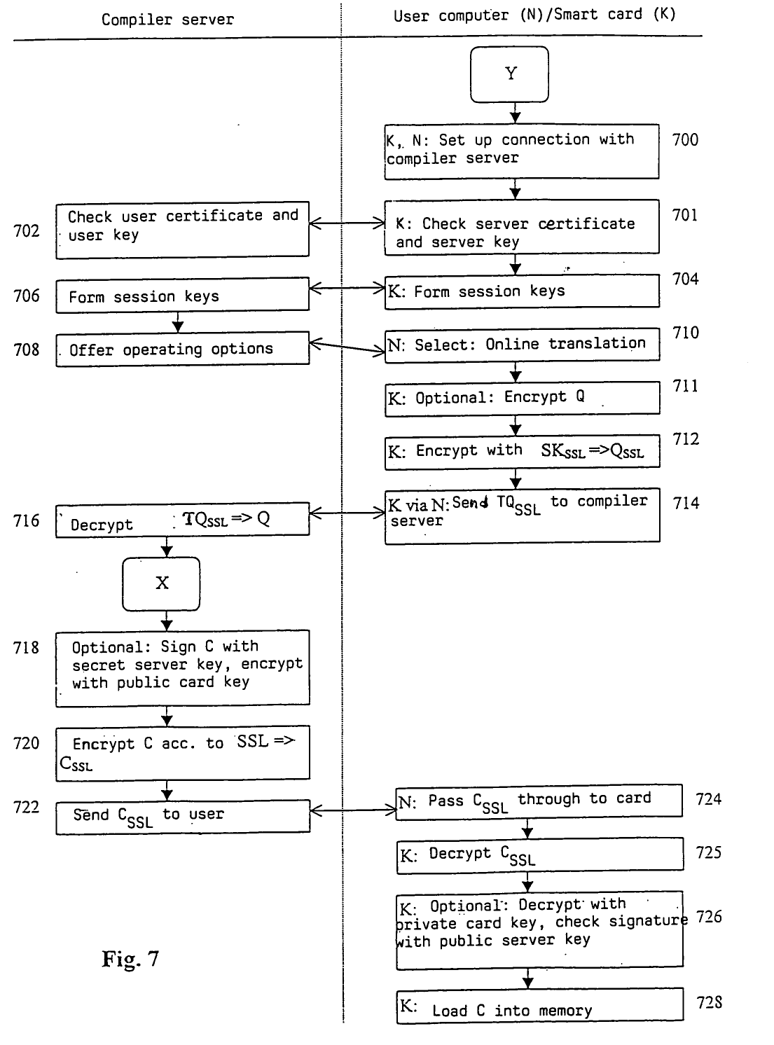

FIG. 7 illustrates an embodiment in which user computer 20 acts substantially only as an intermediary between smart card 10 and compiler server 30. The protection of data transported between smart card 10 and compiler server 30 is effected by directly setting up a secure end-to-end link between compiler server 30 and smart card 10 using the SSL protocol.

Table 1 illustrates systematically the applicability of the three embodiments described below with reference to FIGS. 5, 6, 7 in dependence on the implementation of data transfer, the configuration requirements for smart card 10 and the type of transport security.

TABLE 1

| | Data | Requirement for | |
|---|---|---|---|
| Method | transfer | smart card | Type of transport security |
| | Offline | Only symmetric | Encryption and MAC by |
| | | algorithms | smart card |
| | Online | Symmetric and/or | Secure Messaging by |
| | | asymmetric algorithms | smart card |
| | Online | Symmetric and | SSL by smart card |
| | | asymmetric algorithms | |

The left column in FIGS. 5, 6, 7 shows the activities of compiler server 30, and the right column the activities of user computer 20 or smart card 10, with “N” designating user computer 20 and “K” smart card 10.

The program creation shown in FIG. 5 is preceded by a preparation phase. Therein the user is provided by the issuer with precompleted smart card 10, step 500, and editor 22 to be set up on his computer 20, step 502. Precompleted smart card 10 contains, or includes besides basic configuration 113: identification information ID in memory area 114, program 118 for carrying out symmetric cryptoalgorithms, e.g. the “3DES” algorithm, at least one card-unique key K_{MAC} for forming a data protection code, preferably in the form of a MAC, in memory area 124, at least one key K_{ENC} for symmetric encryption in memory area 126, and memory location 134 for receiving at least two session keys SK_{ENC}, SK_{MAC}. Further, precompleted smart card 10 has at least two sequence counters 136 with values SEQ_{C}, SEQ_{H} set up thereon. Sequence counter SEQ_{C} serves to calculate session keys SK_{ENC}, SK_{MAC} that are used for secure transfer of program source texts Q from user computer 20 to compiler server 30, sequence counter SEQ_{H} serves to calculate session keys SK_{ENC}, SK_{MAC} that are used for secure transfer of program codes C from compiler server 30 to user computer 20.

On compiler server 30 two sequence counters 338 with values SEQ_{C}, SEQ_{H} are set up for each smart card 10 issued. Values SEQ_{C}, SEQ_{H} always match the values of corresponding sequence counters 136 of associated smart card 10 so that compiler server 30 can calculate session keys SK_{ENC}, SK_{MAC} by the same computing rule as smart card 10 uses. To increase security, different session keys SK_{ENC}, SK_{MAC} are used upon each transfer of program source texts Q or program codes C. For this purpose, smart card 10 and compiler server 30 increment values SEQ_{C}, SEQ_{H} of sequence counters 136, 338 before each calculation of session key SK_{ENC}, SK_{MAC}.

Editor 22 allows the creation of program source text Q, e.g. in a high-level programming language. Preferably, it supports program creation by graphically underlaid, dialog-driven input guidance and offers directly usable development aids such as a syntax check or the integration of program interfaces to the code library.

When smart card 10 in precompleted form and user computer 20 are ready, the user employs editor 22 to create program source text Q of a program intended for incorporation into smart card 10, step 504. Preferably, creation is done in a high-level programming language, but any other format is quite generally also possible. When program source text Q is created, the user instructs smart card 10 via editor 22 by means of a corresponding command to encrypt program source text Q and protect it from change with a MAC. For this purpose, smart card 10 first increments sequence counter value SEQ_{C} and generates session keys SK_{ENC} and SK_{MAC}, e.g. with the symmetric 3DES algorithm, step 506. Then it encrypts program source text Q obtained from editor 22 via interfaces 24, 14 with session key SK_{ENC} into intermediate code Q′ and and calculates a MAC for Q′ with session key SK_{MAC}, step 508. Smart card 10 then returns intermediate code Q′ and MAC to editor 22 via interfaces 24, 14.

The editor furthermore determines card identification ID created in memory area 114 of smart card 10, step 509, and combines it with intermediate code Q′ and MAC to form transport code T. User computer 20 transfers thus formed transport code T over data network 28 to compiler server 30, step 510. The transfer of transport code T can be effected here in any desired way via an insecure medium. For example, transport code T can be transferred by e-mail or sent to the issuer on floppy disk by mail. In addition, transport code T can be sent to compiler server 30 over data network 28 online. Privacy and integrity of transferred transport code T are guaranteed by the encryption and the MAC calculation by smart card 10.

When received by compiler server 30, the latter first checks, step 512, whether identification information ID contained in transport code T is also contained in identification list 340 maintained in compiler server 30, which is preferably a customer list. If this applies, it first derives pertinent card-unique keys K_{ENC} and K_{MAC} from master keys MK_{ENC} and MK_{MAC} located in memory areas 324, 326 with the aid of identification information ID, step 514. From said keys and incremented sequence counter SEQ_{C}, compiler server 30 thereupon calculates session keys SK_{ENC} and SK_{MAC} by the same computing rule that smart card 10 previously used. With session key SK_{MAC} compiler server 30 then in turn calculates MAC′, step 516, and compares it with MAC contained in transport code T. In case of a match, compiler server 30 recognizes transport code T as authentic, i.e. as coming from smart card 10 with identification information ID, and as having integrity, i.e. not having been changed during transfer.

When compiler server 30 has recognized transport code T as authentic, it decrypts program source text Q′ contained in transport code T by means of session key SK_{ENC}. Due to the previously ascertained integrity of transport code T, the resulting decrypted format matches program source text Q originally created on user computer 20.

Compiler server 30 converts recovered program source text Q using compilation program 310 into an intermediate format which it then combines with already present program code by means of linking program 312 while accessing code library 318, step 518.

Compilation program 310 and linking program 312 are executed in an expedient design in the form of a hardware security module that comprises the compiling and linking functionality, de- and encryption of the processed program data, check and creation of signatures and authentication. All processed program data, in particular incoming program source texts Q and generated executable program codes C, then appear outside the hardware security module only in encrypted form. In this way it can be ensured that the users' application-specific know-how is protected from inspection and access via compiler server 30.

Expediently a restriction of access to code library 318 can in addition be set up in compiler server 30 to restrict e.g. the linking of already present program codes into a newly generated one by linking program 312.

Program code C resulting after compilation and linking is verified formally by means of verification program 321. Program code C is checked for obvious errors, e.g. address space control, heeding of given memory sizes, type violations or aggressiveness, step 520.

If program code C generated from program source text Q is then usable, i.e. executable by smart card 10, it is changed into transport code U for reverse transfer. For this purpose, sequence counter value SEQ_{H} is first incremented. With incremented sequence counter value SEQ_{H}, card-unique keys K_{ENC} and K_{MAC} are then derived from master keys MK_{ENC}, MK_{MAC} and identification information ID, and session keys SK_{ENC} and SK_{MAC} calculated therewith again, step 522. Calculation of session keys SK_{ENC}, SK_{MAC} by compiler server 30 is done in the same way as previously by user computer 20, in step 506, with only sequence counter value SEQ_{H} being used instead of sequence counter value SEQ_{C}.

Subsequently, program code C is encrypted with session key SK_{ENC} into intermediate code C′ and MAC″ further calculated via intermediate code C′ by means of session key SK_{MAC}, step 524. Intermediate code C′ and MAC″ are thereupon combined into transport code U which compiler server 30 sends to user computer 20, step 526. For sending transport code U, like transport code T, any desired transfer medium can be chosen, in particular also a basically insecure one like a floppy disk or e-mail. It is of course also possible to use an online connection over data network 28. If an online connection is used, it is possible to make an order, i.e. that program source text Q contained in a transport code be sent to compiler 30, and obtain the result, i.e. transport code U with program code C′, in a single online session.

User computer 20 passes obtained transport code U via interfaces 24, 14 to smart card 10, step 528. The latter increments value SEQ_{H} of sequence counter 136, generates therewith session keys SK_{ENC}, SK_{MAC} in the same way as compiler server 30 previously did in step 522, and checks whether MAC″ transferred with transport code U is identical to MAC that smart card 10 can calculate itself from U by means of key SK_{MAC}, step 530. If MAC″ and MAC match, MAC″ from U is successfully verified. Since, besides smart card 10, only compiler server 30 has the possibility to use key SK_{MAC}, program code C obtained by decryption of program code C′ transferred in transport code U is authentic, i.e. it was generated by compiler server 30 from program source text Q transport-secured by the same smart card 10. Program code C recognized as authentic is loaded by smart card 10 into card memory 113, step 532.

FIG. 6 shows the flowchart of an embodiment of a distributed program creation in which the data transfer effected between user computer 20 and compiler server 30 over data network 28 is secured by SSL, while the direct data transport between smart card 10 and compiler server 30 is effected with the aid of the Secure Messaging mechanism. Like the embodiment shown in FIG. 5, this embodiment is particularly suitable for online execution in systems in which smart cards 10 used allow only symmetric encryption techniques.

Smart card 10 precompleted for carrying out the second embodiment comprises not only basic configuration 110 with operating system 111, basic program code 112 and memory space 113 for completion program code but also routine 120 for carrying out Secure Messaging, private card key 130 and public server key 128. User computer 20 further has the program functionality for executing the SSL protocol without authentication of smart cards.

The implementation of a program creation in the second embodiment initially corresponds to the first embodiment according to FIG. 5 and comprises steps 500 to 504.

When program source text Q is present, the user sets up a connection between his computer 20 and the issuer's compiler server 30 over data network 28, step 600.

When the physical connection with compiler server 30 is established, an SSL protocol is started between user computer 20 and compiler server 30. User computer 20 and compiler server 30 each determine session key SK_{SSL}, steps 601, 602. Then a so-called IP tunnel between compiler server 30 and smart card 10 is set up within the SSL protocol for executing Secure Messaging, step 604. In user computer 20 the Secure Messaging protocol performed by smart card 10 is embedded into the SSL protocol used only between user computer 20l and compiler server 30. In the IP tunnel smart card-specific records, preferably in the form of APDUs (Application Protocol Data Units) are subsequently transported directly between smart card 10 and compiler server 30. With respect to Secure Messaging, user computer 20 acts only as a mere intermediary.

According to Secure Messaging, smart card 10 and compiler server 30 then perform reciprocal authentication, whereby card 10 first authenticates itself vis-à-vis compiler server 30, step 606, and then compiler server 30 vis-à-vis card 10, step 608. If reciprocal authentication between smart card 10 and compiler server 30 is successful, the use of all functions of compiler server 30 by user computer 20 is released, step 610.

When the release of use is present, user computer 20 encrypts created program source text Q with previously determined session key SK_{SES} and transfers resulting transport code TQ to compiler server 30, step 612.

When received in compiler server 30, transport code TQ is decrypted again with the aid of session key SK_{SSL} previously generated in compiler server 30, step 614, and converted into source text Q created on user computer 20. The execution of steps 610, 612, 614 is expediently done in the form of a continuous data exchange between user computer 20 and compiler server 30, so that the recovery of source text Q in compiler server 30 is completed immediately after receipt of the last encrypted source text record from user computer 20.

From source text Q, compiler server 30 thereupon generates executable program code C by performing steps 518 and 520 described with reference to FIG. 5.

Compiler server 30 changes executable program code C into secure program code C_{SM} by applying the Secure Messaging mechanisms, step 620. It then converts secure program code C_{SM} into transport code UC_{SM} present in a transient format by encryption with the aid of session key SK_{SES}, step 622. By encryption with session key SK_{SES}, secure program code C_{SM}, typically present in the form of APDUs, is embedded into a security mechanism for data transfer over data network 28 between compiler server 30 and user computer 20.

Compiler server 30 transfers transport code UC_{SM} present in the transient format to user computer 20. The latter decrypts UC_{SM} by means of session key SK_{SES}, step 626, thereby removing the security mechanism provided for protecting data transfer between compiler server 30 and user computer 20. User computer 20 passes then present decrypted program code C_{SM} secured according to Secure Messaging to smart card 10, step 624.

In smart card 10, secure program code C_{SM} is returned to executable program code C by application of the reversing Secure Messaging mechanisms, step 628, and finally loaded into memory array 104 in area 113 prepared there for receiving completion program code, step 630.

For reasons of clarity, the course of procedure shown in FIG. 6 was described hereinabove as a sequential series of separate steps. In practice, the data transfers effected between smart card 10, user computer 20 and compiler server 30 normally comprise data exchange in both directions. It is moreover expedient to perform method steps for which this is possible in the form of a continuous, quasi parallel data exchange and processing process, in which compiler server 30 and user computer 20 or smart card 10 perform method steps in time overlap. This is expedient e.g. for steps 620 to 630: they are preferably performed in the form of a continuous data exchange between compiler server 30 and user computer 20, in which records of transport code UC_{SM} are already being transferred to user computer 20 while program code C is still being converted according to Secure Messaging on compiler server 30, and in which the records transferred from compiler server 30 via user computer 20 to smart card 10 are decrypted by said card immediately before loading into memory space 113, i.e. without being stored intermediately until completely received.

FIG. 7 illustrates a further embodiment of the program creation described with reference to FIG. 4 in which user computer 20 acts substantially only as an intermediary between smart card 10 and compiler server 30. The protection of data transported between smart card 10 and compiler server 30 is effected by setting up a secure, direct end-to-end link between compiler server 30 and smart card 10 using the SSL protocol.

The precompletion of smart card 10 suitable for carrying out this embodiment involves not only setting up basic configuration 110 with operating system 111, basic program code 112 and memory area for completion program code 113 but also creating program 122 for executing the SSL protocol, depositing certificate 132, depositing private card key 130 and depositing public server key 128.

The implementation of the method according to FIG. 7 initially corresponds to the embodiment described with reference to FIG. 5 and comprises steps 500 to 504. They are followed by establishment of a connection between smart card 10 and compiler server 30 via user computer 20, step 700.

Smart card 10 and compiler server 30 now conduct a complete SSL protocol. Reciprocal authentication is effected within the handshake procedure by compiler server certificate 332 firstly being checked by smart card 10, step 701, and certificate 132 created in smart card 10 secondly being checked by compiler server 30, step 702. If If continuation of data exchange is possible after the reciprocal certificate check, smart card 10 and compiler server 30 each generate a session key, steps 704, 706.

The embodiment illustrated in FIG. 7 is particularly suitable for online implementation. After a secure data link is established between smart card 10 and compiler server 30 it can therefore be provided that the user must choose from a selection of several possible operating options for further processing. In this case, compiler server 30 sends an offer message on the possible operating options to user computer 20 after the secure data link is established, step 708. From the conveyed options the user selects via user computer 20 the desired one, e.g. a program creation with online translation, step 710, or a debug mode, in which the executability of a newly generated program code is ascertained online.

To increase the security of data transfer to compiler server 30, a signature of program source text Q can subsequently optionally be provided by smart card 10, step 711. The signature is effected in the way known in the art by smart card 10 forming a hash value over source text Q and encrypting it with private key 130 of the smart card. Hash value formation can be effected by user computer 20, in particular if there are insufficient hardware resources on smart card 10.

Smart card 10 encrypts the optionally signed program source text code with previously determined session key SK_{SSL} into transport code TQ_{SSL}, step 712, which it then sends via user computer 20 to compiler server 30, step 714.

The latter decrypts received transport code TQ_{SSL} with session key SK_{SES}, step 716, to recover program source text Q. If a signature is present, it checks its correctness by again forming the hash value using public card key 332.

From recovered program source text Q, compiler server 30 then generates executable program code C by performing steps 518, 520.

Compiler server 30 provides generated program code C with a signature that it generates by forming a hash value and encrypting the hash value with private key 330 of compiler server 30. It thereupon encrypts the resulting signed code with public key 332 of smart card 10, step 718. Compiler server 30 subsequently converts the then present cipher by encryption with session key SK_{SES} into transient format C_{SSL}, step 720, which it finally transfers as transport code to user computer 20, step 722.

The latter passes received transport code C_{SSL} to smart card 10, step 724, which again generates the cipher of the executable program code therefrom by decryption with session key SK_{SES}, step 725. If program code C was signed in compiler server 30, smart card 10 further decrypts the cipher with private key 130 of smart card 10 and checks the then present signature with public key 128 of compiler server 30, step 726. If the result of the signature check is positive, smart card 10 loads thus present executable program code C into memory array 104 in memory space 113 provided for receiving completion program code, step 728.

As in the embodiment according to FIG. 5, the course of procedure shown in FIG. 7 has been described sequentially for clarity's sake. However, in practice it is expedient to perform method steps for which this is possible quasi in parallel, by compiler server 30 and smart card 10 performing them in time overlap. This applies e.g. to steps 712 to 716, i.e. encryption by the smart card and recovery of program source text Q by the compiler server. They are expediently effected in the form of a continuous, quasi-parallel data exchange and processing process, so that program source text Q is present in compiler server 30 virtually immediately after the last record is sent by smart card 10. There is no intermediate storage of program source text Q until it is completely received. Further, a realization in the form of a continuous, quasi-parallel data exchange and processing process is also recommendable for steps 718 to 728, i.e. for encryption of executable program code C by the compiler server and the recovery thereof by the smart card and loading into memory space 113 on smart card 10. These steps are expediently performed by compiler server 30 and smart card 10 directly record by record without intermediate storage, so that executable program code C is present in the memory of smart card 10 substantially immediately after the last transport code record has been sent by compiler server 30.

During a program creation according to one of the above-described embodiments, the implementation of a debug routine can be provided. This is done to check check program code C created by compiler server 30 for executability before it is loaded onto smart card 10. The principle of such a debug routine is illustrated in FIG. 8, whereby the measures directed to securing data transfer, i.e. especially the different encryptions, are omitted to simplify the description.

The debug routine is created as program 316 in compiler server 30 and also executed there. Additionally or as a part of program 316, it comprises hardware simulating a data carrier and/or software simulating a data carrier for emulating a generated program on compiler server 30 under the technical constraints present on the data carrier. It is controlled via editor 22 in user computer 20, after a corresponding operating mode has been set in compiler server 30. The operating mode can be set e.g. during the selection of an operating option in steps 708 and 710 if the program creation is performed according to the embodiment shown in FIG. 6. The debug operating mode makes it possible, for instance, to start a program generated in compiler server 30, set stop marks, display memory areas and read and set variables, all from user computer 20. For executing the debug routine, program source text Q is first created in the usual way, step 504, and a connection to compiler server 30 set up, step 700. Then source text Q is transferred to compiler server 30 according to one of the above-described embodiments, step 800.

When source text Q has been received, compiler server 30 offers the user the generation of program code C in the debug operating mode, step 802. A user can then select the mode via user computer 20, step 804. If the debug operating mode was chosen, compiler server 30 creates from received program source text Q by performing steps 526, 528 preliminary program code Cᵥ that is executable in the simulation and/or emulation environment present in compiler server 30. Compiler server 30 stores preliminary program code Cᵥ in a temporary memory, step 806. Then it transfers a create message to user computer 20, step 808, which displays it, step 810.

The user can now by means of user computer 20 provide source text program Q with debug instructions, i.e. set stop marks, execute a program in single steps or display variables, step 812. The debug instructions are conveyed to compiler server 30.

Subsequently, the execution of the program realized by preliminary program code Cᵥ can be triggered on compiler server 30 via user computer 20, step 814. Compiler server 30 thereupon executes the program with consideration of the previously conveyed debug instructions, step 816. After each execution of a program division defined by the debug instructions, it conveys a result message to user computer 20, step 818, which the latter displays, step 820. Depending on the given debug instructions, an intervention by a user in the program execution can thereupon be provided, e.g. by inputting variables or setting new debug instructions, step 822. User computer 20 conveys any interventions made in program source text Q or new debug instructions to compiler server 30. When a debug instruction has finally been executed, user computer 20 conveys a continuation signal to compiler server 30, step 824, whereupon the latter causes the next program division to be executed by repeating step 814. It takes account of any interventions made in program source text Q or new debug instructions. Steps 814 to 824 are repeated until compiler server 30 has completely executed a program realized by preliminary program code Cᵥ.

If the program finally proves to be executable without errors, the user causes a change of operating mode to the standard mode via user computer 20, step 826. Compiler server 30 thereupon generates executable program code C from program source text Q present at this time, and transfers it to smart card 10 via user computer 20, as described with reference to FIGS. 4 to 6, step 828. In addition, it erases buffered preliminary program code Cᵥ, step 830.

The above-described sequence of examples is to be understood as a basis for specifically realizing the method in each case. While retaining the basic approach of using precompleted data carriers to obtain a secure program creation, the examples can each be elaborated within broad limits. This applies in particular to the execution of the structural elements, i.e. smart card, user computer, data network and compiler server. Further, the stated encryption and authentication methods can of course be replaced with others having the same security effect. All described embodiments can be raised to an even higher security level in particular by using further keys, sequence counters or other cryptographic algorithms. For technical or security reasons, further reformatting can also be provided. Thus, it is customary in particular in programmable smart smart cards, in view of their limited memory space, to reformat an executable program code generated on compiler server 30 to optimize memory before or while it is loaded into the smart card, by for example replacing symbolic referencings with actual addresses. Further, for reasons of clarity only no-error cases have been described here. However, the treatment of error cases can be derived therefrom using known standard solutions.

1. A method for distributed creation of an executable program for a programmable portable data carrier, a program source text being created on a first computer located with a user, the program source text being compiled and linked into an executable program code, after transfer, on a second computer located with the issuer of the data carrier, and the executable program code being loaded into the data carrier after reverse transfer via the first computer, characterized in that
in a precompletion step, software tools for final processing are created on the data carrier (10) that allow an executable program code (C) to be obtained from a transport code (U, UC_{SM}, C_{SSL}) present in a transient format,
executable program code (C) generated in the second computer (30) is converted into transport code (U, UC_{SM}, C_{SSL}) for reverse transfer, and
transport code (U, UC_{SM}, C_{SSL}) retransferred to the first computer (20) for incorporation in the data carrier (10) is reconverted into executable program code (C) by means of the software tools.

2. A method according to claim 1, characterized in that the program source text (Q) created on the first computer (20) is given a transport security mechanism for transfer to the second computer (30) by being encrypted.

3. A method according to claim 1, characterized in that the software tools comprise identification information (114) designating a data carrier (10), and a signature key (124).

4. A method according to claim 1, characterized in that the software tools comprise a program for carrying out an SSL handshake protocol (122) and/or a program for carrying out Secure Messaging (120).

5. A method according to claim 1, characterized in that the software tools comprise a private data carrier key (130) and a program for testing a signature with the public key (128) of a second computer (30).

6. A method according to claim 1, characterized in that executable program code (C) to be loaded into the portable data carrier (10) is executed with the involvement of the second computer (30) to determine possible errors.

7. A method according to claim 6, characterized in that executable program code (C) to be loaded into the portable data carrier (10) is executed on the second computer (30) with the involvement of the first computer (20).

8. A method according to claim 1, characterized in that the executable program code (C) is stored in the memory (113) of the data carrier (10).

9. A programmable portable data carrier with an integrated circuit having a processor and a memory for receiving program code executable by the processor, characterized in that software tools for final processing are created in the integrated circuit (12) that permit a transport code (U, UC_{SM}, C_{SSL}) supplied in a transient format to be converted into executable program code (C).

10. A data carrier according to claim 9, characterized in that it has at least one sequence counter (136).

11. A data carrier according to claim 9, characterized in that it contains identification information (114) designating the data carrier (10), and a key (124) for forming a data protection code, which associate it with a defined second computer (30).

12. A computer for carrying out a distributed creation of an executable program for a programmable portable data carrier, containing at least a compilation program and a linking program (312), characterized in that it has means for recovering a program source text (Q) from a received transport code (T, TQ, TQ_{SSL}) present in a transient format.

13. A computer according to claim 12, characterized in that it has means for detecting and checking the identity of a data carrier (10) to be programmed.

14. A computer according to claim 12, characterized in that it maintains a table (340) storing identification information (114) designating the data carrier for each portable data carrier (10) that is programmable by means of the computer (30).

15. A computer according to claim 12, characterized in that it has means (321) for formal verification of a program code (C) generated by compilation.

16. A computer according to claim 12, characterized in that it has means (316) for checking a generated program code (C) by direct execution as to whether it contains errors.

17. A computer for carrying out a distributed creation of an executable program for a programmable portable data carrier, containing at least a first interface for data exchange with a data carrier and a second interface to a data link, characterized in that
it has means for executing an editing program (22) for creating a program source text (Q) not executable by the computer (20) itself,
and it has means permitting, via the first and second interfaces (24, 26), direct data transfer between a portable data carrier (10) and a second computer (39) connected via the data link (28).

18. A computer according to claim 17, characterized in that it has means for executing an SSL protocol.

19. A system for distributed creation of an executable program for a programmable portable data carrier, comprising a portable data carrier according to claim 9 and a computer according to claim 12.

20. A system according to claim 20, characterized in that it further comprises a computer according to claim 17.
